(19) United States
(12) Patent Application Publication
(10) Pub. No.: US 2011/0142135 A1
(43) Pub. Date: Jun. 16, 2011

(54) Adaptive Use of Quarter-Pel Motion Compensation

(76) Inventors: Madhukar Budagavi, Plano, TX (US); Minhua Zhou, Plano, TX (US); Hyung Joon Kim, McKinney, TX (US)

(21) Appl. No.: 12/637,742

(22) Filed: Dec. 14, 2009

(51) Int. Cl. H04N 7/26

(52) U.S. Cl. 375/240.17; 375/E07.124

(57) ABSTRACT

A method of encoding a digital video sequence is provided that includes disabling quarter-pel motion compensation for a first sequence of blocks in the digital video sequence, computing an average half-pel cost for the first sequence of blocks, computing an average quarter-pel cost for the first sequence of blocks, and enabling quarter-pel motion compensation for a second sequence of blocks in the digital video sequence based on a comparison of the average half-pel cost and the average quarter-pel cost.

### BACKGROUND OF THE INVENTION

The demand for digital video products continues to increase. Some examples of applications for digital video include video communication, security and surveillance, industrial automation, and entertainment (e.g., DV, HDTV, satellite TV, set-top boxes, Internet video streaming, digital cameras, cellular telephones, video jukeboxes, high-end displays and personal video recorders). Further, video applications are becoming increasingly mobile as a result of higher computation power in handsets, advances in battery technology, and high-speed wireless connectivity.

Video compression is an essential enabler for digital video products. Compression-decompression (CODEC) algorithms enable storage and transmission of digital video. MPEG-4, developed by the Moving Picture Experts Group (MPEG), is an ISO/IEC standard that is used in many digital video products for video compression. Specifically, the MPEG-4 video compression standard is defined in “Generic Coding of Audio-Visual Objects. Part 2: Visual” (MPEG-4 Visual). The encoding process of MPEG-4 Visual generates coded representations of video object planes (VOPs). A VOP is defined as instances of video objects at a given time and a video object is defined as an entity in a scene that a user can access and manipulate. Further, a video object may be an entire frame of a video sequence or a subset of a frame.

An MPEG-4 bit stream, i.e., encoded video sequence, may include three types of VOPs, intracoded VOPs (I-VOPs), predictive coded VOPs (P-VOPS), and bi-directionally coded VOPs (B-VOPs). I-VOPs are coded without reference to other VOPs. P-VOPs are coded using motion compensated prediction from I-VOPS or P-VOPS. B-VOPs are coded using motion compensated prediction from both past and future reference VOPs. For encoding, all VOPs are divided into macroblocks, e.g., 16×16 pixels in the luminance space and 8×8 pixels in the chrominance space for the simplest sub-sampling format.

MPEG-4 coding, as well as other coding in other video coding standards, is based on the hybrid video coding technique of block motion compensation and transform coding. Block motion compensation is used to remove temporal redundancy between blocks of a VOP and transform coding is used to remove spatial redundancy in the video sequence. Traditional block motion compensation schemes basically assume that objects in a scene undergo a displacement in the x- and y-directions from one VOP to the next. Motion vectors are signaled from the encoder to the decoder to describe this motion. The decoder then uses the motion vectors to predict current VOP data from previous reference VOPs. Older standards such as H.261 signaled motion vectors in integer precision. Subsequent standards such as H.263 and MPEG-2 signaled motion vectors in half-pel precision. MPEG-4 and H.264 support signaling of motion vectors in quarter-pel precision. Specifically, quarter-pel motion compensation (QPelMC) is defined in the MPEG-4 Advanced Simple Profile (ASP).

In MPEG-4 ASP, the use of QPelMC is controlled by the user of a codec. Typically, a user will encode a video sequence twice, once with QPelMC enabled and once with QPelMC disabled. The smaller of the two compressed bit streams is then selected. Using this approach to finding the best coding option for a video sequence can consume a lot of time and resources, especially if the video sequence is long, e.g., a movie. In addition, while the use of QPelMC for an entire video sequence may result in coding gains for some video sequences, studies have shown that the use of QPelMC may result in quality degradation, e.g., reduction in peak signal-to-noise ratio (PSNR), for other video sequences.

### BRIEF DESCRIPTION OF THE DRAWINGS

Particular embodiments in accordance with the invention will now be described, by way of example only, and with reference to the accompanying drawings:

FIG. 1 shows a block diagram of a digital system in accordance with one or more embodiments of the invention;

FIG. 2 shows a block diagram of a video encoder in accordance with one or more embodiments of the invention;

FIGS. 3, 4A, and 4B show flow diagrams of methods in accordance with one or more embodiments of the invention; and

FIGS. 5-7 show illustrative digital systems in accordance with one or more embodiments of the invention.

### DETAILED DESCRIPTION OF EMBODIMENTS OF THE INVENTION

Specific embodiments of the invention will now be described in detail with reference to the accompanying figures. Like elements in the various figures are denoted by like reference numerals for consistency.

Certain terms are used throughout the following description and the claims to refer to particular system components. As one skilled in the art will appreciate, components in digital systems may be referred to by different names and/or may be combined in ways not shown herein without departing from the described functionality. This document does not intend to distinguish between components that differ in name but not function. In the following discussion and in the claims, the terms “including” and “comprising” are used in an open-ended fashion, and thus should be interpreted to mean “including, but not limited to . . . ” Also, the term “couple” and derivatives thereof are intended to mean an indirect, direct, optical, and/or wireless electrical connection. Thus, if a first device couples to a second device, that connection may be through a direct electrical connection, through an indirect electrical connection via other devices and connections, through an optical electrical connection, and/or through a wireless electrical connection.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description. In addition, although method steps may be presented and described herein in a sequential fashion, one or more of the steps shown and described may be omitted, repeated, performed concurrently, and/or performed in a different order than the order shown in the figures and/or described herein. Accordingly, embodiments of the invention should not be considered limited to the specific ordering of steps shown in the figures and/or described herein. Further, while various embodiments of the invention are described herein in accordance with the MPEG-4 video coding standard, embodiments for other video coding standards will be understood by one of ordinary skill in the art. For example, although description of embodiments use MPEG-4 terminology for describing contents of a digital video sequence (e.g., video object plane (VOP), and group of VOPs (GOV)), one of ordinary skill in the art will understand that the concepts described are similar to the terminology used for describing such contents in other standards (e.g., frame, picture, group of pictures (GOP). Accordingly, embodiments of the invention should not be considered limited to the MPEG-4 video coding standard.

In general, embodiments of the invention provide for adaptive use of quarter-pel motion compensation (QpelMC) when coding digital video sequences. More specifically, in one or more embodiments of the invention, a determination of whether or not to use quarter-pel motion compensation for a group of VOPs (GOV) in a digital video sequence is made based on a cost for using half-pel motion compensation and a cost for using quarter-pel motion compensation computed for the previous GOV as the previous GOV is coded. A comparison of these two costs is made to decide whether quarter-pel motion compensation is to be used for the current GOV. In one or more embodiments of the invention, if the difference between the half-pel cost and the quarter-pel cost for the previous GOV is above a threshold, quarter-pel motion compensation is used for the current GOV. Further, in one or more embodiments of the invention, an M-tap filter, a bilinear filter, or both types of filters are used for half-pel interpolation. In some embodiments of the invention, when both filter types are used for half-pel interpolation, a bilinear filter is used when half-pel motion compensation is to be used to code the GOV and an M-tap filter is used when quarter-pel motion compensation is used to code the GOV.

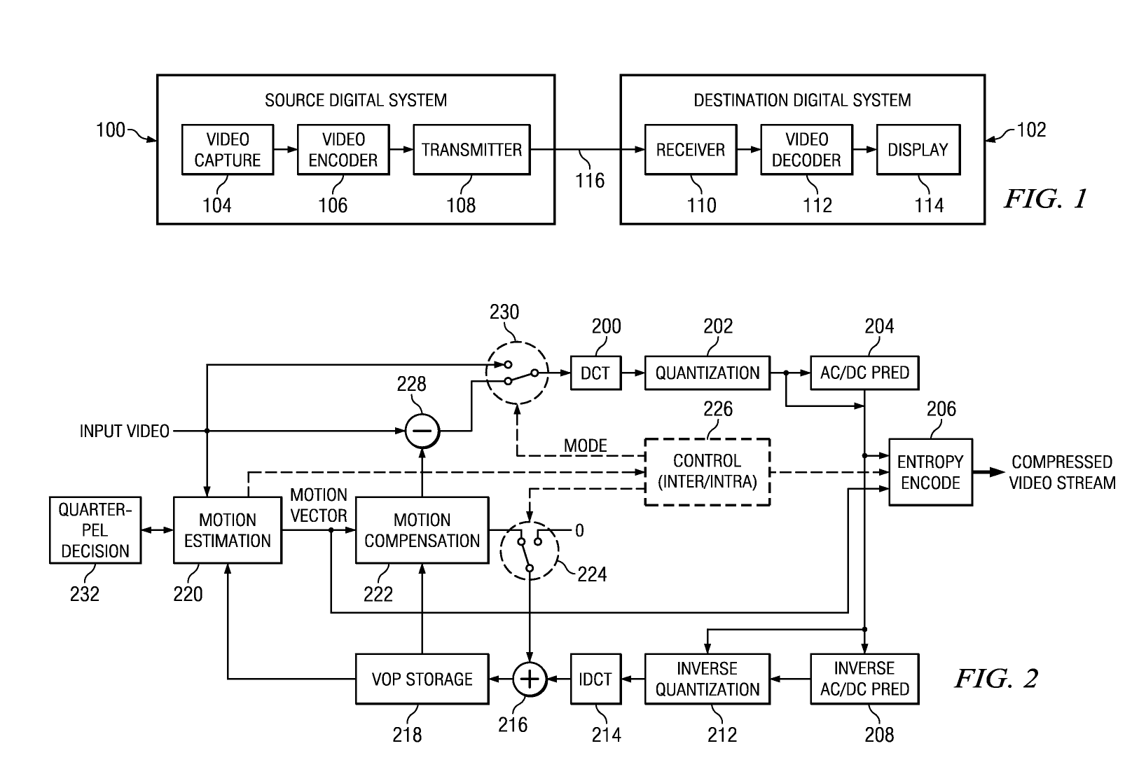

FIG. 1 shows a block diagram of a digital system in accordance with one or more embodiments of the invention. The digital system is configured to perform coding of digital video sequences using embodiments of the methods for adaptive use of quarter-pel motion compensation described herein. The system includes a source digital system (100) that transmits encoded video sequences to a destination digital system (102) via a communication channel (116). The source digital system (100) includes a video capture component (104), a video encoder component (106) and a transmitter component (108). The video capture component (104) is configured to provide a video sequence to be encoded by the video encoder component (106). The video capture component (104) may be for example, a video camera, a video archive, or a video feed from a video content provider. In some embodiments of the invention, the video capture component (104) may generate computer graphics as the video sequence, or a combination of live video and computer-generated video.

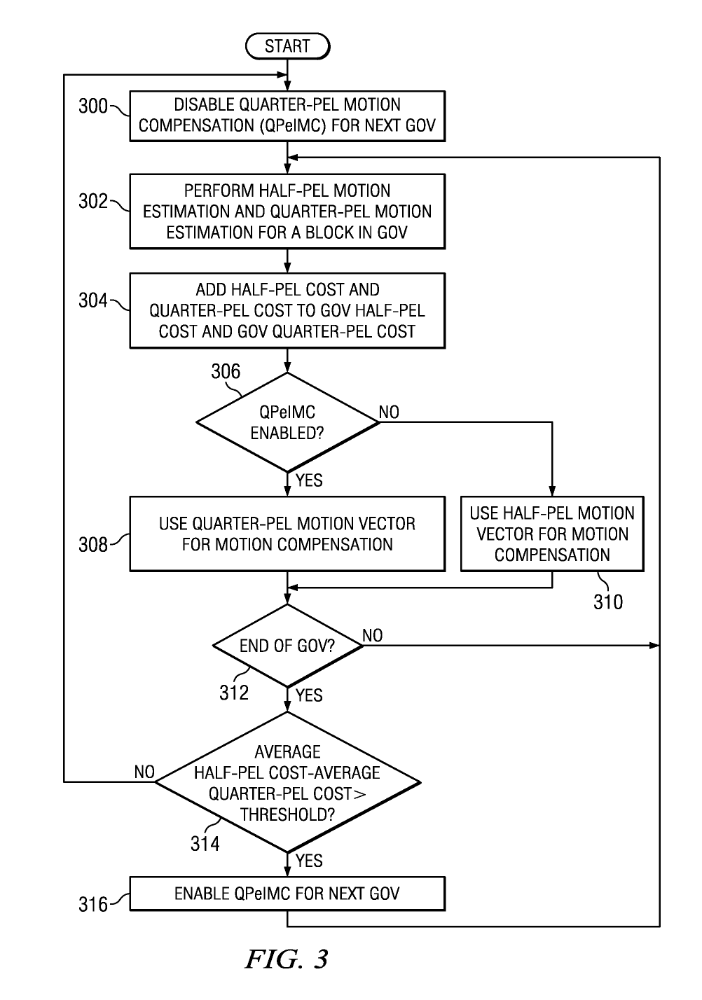

The video encoder component (106) receives a video sequence from the video capture component (104) and encodes it for transmission by the transmitter component (1108). In general, the video encoder component (106) receives the video sequence from the video capture component (104) as a sequence of VOPs, divides the VOPs into coding units which may be a whole VOP or a part of a VOP, divides the coding units into blocks of pixels, and encodes the video data in the coding units based on these blocks. During the encoding process, a method for adaptive use of quarter-pel motion compensation in accordance with one or more of the embodiments described herein is used. The functionality of embodiments of the video encoder component (106) is described in more detail below in reference to FIG. 2.

The transmitter component (108) transmits the encoded video data to the destination digital system (102) via the communication channel (116). The communication channel (116) may be any communication medium, or combination of communication media suitable for transmission of the encoded video sequence, such as, for example, wired or wireless communication media, a local area network, or a wide area network.

The destination digital system (102) includes a receiver component (110), a video decoder component (112) and a display component (114). The receiver component (110) receives the encoded video data from the source digital system (100) via the communication channel (116) and provides the encoded video data to the video decoder component (112) for decoding. In general, the video decoder component (112) reverses the encoding process performed by the video encoder component (106) to reconstruct the VOPs of the video sequence. The reconstructed video sequence may then be displayed on the display component (114). The display component (114) may be any suitable display device such as, for example, a plasma display, a liquid crystal display (LCD), a light emitting diode (LED) display, etc.

In some embodiments of the invention, the source digital system (100) may also include a receiver component and a video decoder component and/or the destination digital system (102) may include a transmitter component and a video encoder component for transmission of video sequences both directions for video steaming, video broadcasting, and video telephony. Further, the video encoder component (106) and the video decoder component (112) may perform encoding and decoding in accordance with one or more video compression standards such as, for example, the Moving Picture Experts Group (MPEG) video compression standards, e.g., MPEG-1, MPEG-2, and MPEG-4, the ITU-T video compressions standards, e.g., H.263 and H.264, the Society of Motion Picture and Television Engineers (SMPTE) 421 M video CODEC standard (commonly referred to as “VC-1”), the video compression standard defined by the Audio Video Coding Standard Workgroup of China (commonly referred to as “AVS”), etc. The video encoder component (106) and the video decoder component (112) may be implemented in any suitable combination of software, firmware, and hardware, such as, for example, one or more digital signal processors (DSPs), microprocessors, discrete logic, application specific integrated circuits (ASICs), field-programmable gate arrays (FPGAs), etc.

FIG. 2 shows a block diagram of a video encoder e.g., the video encoder (106) of FIG. 1, in accordance with one or more embodiments of the invention. More specifically, FIG. 2 shows the basic coding architecture of an MPEG-4 video encoder configured to perform adaptive quarter-pel motion compensation.

In the video encoder of FIG. 2, VOPs of an input digital video sequence are provided as one input of a motion estimation component (220), as one input of a mode conversion switch (230), and as one input to a combiner (228) (e.g., adder or subtractor or the like). The VOP storage component (218) provides reference data to the motion estimation component (220) and to the motion compensation component (222). The reference data may include one or more previously encoded and decoded VOPs. The motion estimation component (220) provides motion estimation information to the motion compensation component (222), the mode control component (226), and the entropy encode component (206). More specifically, the motion estimation component (220) processes each macroblock in a VOP and performs searches based on the prediction modes defined in the standard to choose the best motion vector(s)/prediction mode for each macroblock. The motion estimation component (220) provides the selected motion vector (MV) or vectors to the motion compensation component (222) and the entropy encode component (206), and the selected prediction mode to the mode control component (226).

The mode control component (226) controls the two mode conversion switches (224, 230) based on the prediction modes provided by the motion estimation component (220). When an interprediction mode is provided to the mode control component (226), the mode control component (226) sets the mode conversion switch (230) to feed the output of the combiner (228) to the DCT component (200) and sets the mode conversion switch (224) to feed the output of the motion compensation component (222) to the combiner (216). When an intraprediction mode is provided to the mode control component (226), the mode control component (226) sets the mode conversion switch (230) to feed input VOP to the DCT component (200) and sets the mode conversion switch (224) to feed the output of the motion compensation component (222) to a null output.

The motion compensation component (222) provides motion compensated prediction information based on the motion vectors received from the motion estimation component (220) as one input to the combiner (228) and to the mode conversion switch (224). The motion compensated prediction information includes motion compensated interVOP macroblocks, i.e., prediction macroblocks. The combiner (228) subtracts the selected prediction macroblock from the current macroblock of the current input VOP to provide a residual macroblock to the mode conversion switch (230). The resulting residual macroblock is a set of pixel difference values that quantify differences between pixel values of the original macroblock and the prediction macroblock.

The mode conversion switch (203) then provides either the residual macroblock or the current macroblock to the DCT component (200) based on the current prediction mode. The DCT component (200) performs a block transform, e.g., discrete cosine transform (DCT), on the macroblock and outputs the transform result. The transform result is provided to a quantization component (202) which outputs quantized transform coefficients. The quantized transform coefficients are provided to the DC/AC (Discrete Coefficient/Alternative Coefficient) prediction component (204). AC is typically defined as a DCT coefficient for which the frequency in one or both dimensions is non-zero (higher frequency). DC is typically defined as a DCT coefficient for which the frequency is zero (low frequency) in both dimensions. The DC/AC prediction component (204) predicts the AC and DC for the current macroblock based on AC and DC values of adjacent macroblocks such as an adjacent left top macroblock, a top macroblock, and an adjacent left macroblock. More specifically, the DC/AC prediction component (204) calculates predictor coefficients from quantized coefficients of neighboring macroblocks and then outputs the differentiation of the quantized coefficients of the current macroblock and the predictor coefficients. The differentiation of the quantized coefficients is provided to the entropy encode component (206), which encodes them and provides a compressed video bit stream for transmission or storage. The entropy coding performed by the entropy encode component (206) may be any suitable entropy encoding techniques, such as, for example, context adaptive variable length coding (CAVLC), context adaptive binary arithmetic coding (CABAC), run length coding, etc.

Inside every encoder is an embedded decoder. As any compliant decoder is expected to reconstruct an image from a compressed bit stream, the embedded decoder provides the same utility to the video encoder. Knowledge of the reconstructed input allows the video encoder to transmit the appropriate residual energy to compose subsequent frames. To determine the reconstructed input, the quantized transform coefficients from the quantization component (202) are provided to an inverse quantize component (212) which outputs estimated transformed information, i.e., an estimated or reconstructed version of the transform result from the DCT component (200). The estimated transformed information is provided to the inverse DCT component (214), which outputs estimated residual information which represents a reconstructed version of the residual macroblock. The reconstructed residual macroblock is provided to a combiner (216). The combiner (216) adds the predicted macroblock from the motion compensation component (222) (if available) to the reconstructed residual macroblock to generate an unfiltered reconstructed macroblock, which becomes part of reconstructed VOP information. The reconstructed VOP information, i.e., reference VOP, is stored in the VOP storage component (218) which provides the reconstructed VOP information as reference VOPs to the motion estimation component (220) and the motion compensation component (222).

In one or more embodiments of the invention, the motion estimation component (220) and the motion compensation component (222) are configurable to operate at half-pel precision or quarter-pel precision. In some embodiments of the invention, the default level of resolution for the motion estimation component (220) and the motion compensation component (222) is half-pel and the level of resolution may be optionally changed to quarter-pel. The precision level to be used for motion compensation for each GOV may be controlled by the quarter-pel decision component (232). As is described in more detail below, the quarter-pel decision component (232) uses cost information provided by the motion estimation component (220) as motion vectors are generated for a GOV to determine whether to enable or disable quarter-pel motion compensation for the next GOV.

For each macroblock in a GOV, the motion estimation component (220) performs half-pel searches to generate the best half-pel motion vector for the block and quarter-pel searches to generate the best quarter-pel motion vector for the block. The motion estimation component (220) may use any suitable motion estimation technique, such as, for example, a hierarchical search, a predictor-based search, a three step search, a window-based search, etc., and may use any suitable techniques for interpolating the half-pel and quarter-pel values. In some embodiments of the invention, an M-tap filter is used to calculate the half-pel values and a bilinear filter is used to calculate the quarter-pel values from the half-pel values. In some embodiments of the invention, a bilinear filter is used to calculate both the half-pel values and the quarter-pel values. In some embodiments of the invention, when quarter-pel motion compensation is disabled for a GOV, a bilinear filter is used to calculate both the half-pel values and the quarter-pel values, and when quarter-pel motion compensation is enabled for a GOV, an M-tap filter is used to calculate the half-pel values and a bilinear filter is used to calculate the quarter-pel values. In one or more embodiments of the invention, the value of M is 8 as specified by MPEG-4 ASP. In other embodiments of the invention, for purposes of performance optimization, the value of M is 6.

The motion estimation component (220) selects the best half-pel motion vector based on motion vector evaluation criteria calculated for the half-pel motion vector, i.e., a half-pel cost, and the best quarter-pel motion vector based on motion vector evaluation criteria calculated for the quarter-pel motion vector, i.e., a quarter-pel cost. The half-pel cost and quarter-pel cost may be calculated using any suitable technique. In some embodiments of the invention, the half-pel cost and quarter-pel cost are computed as distortion +λ*MV_cost, where the distortion is computed as the sum of absolute differences (SAD) between each pixel in the macroblock and the corresponding pixel in the reference macroblock, MV_cost (motion vector cost) represents the cost of encoding the motion vector (e.g., number of bits needed to encode the motion vector), and the parameter λ is the Lagrangian multiplier used to adjust the relative weights of the distortion and MV_cost. The motion estimation component (220) provides the half-pel cost for the selected half-pel motion vector and the quarter-pel cost for the selected quarter-pel motion vector to the quarter-pel decision component (232), if quarter-pel motion compensation is currently enabled, the motion estimation component provides the selected quarter-pel motion vector to the motion compensation component (222). Otherwise, the motion estimation component provides the selected half-pel motion vector to the motion compensation component (222).

The quarter-pel decision component (232) accumulates the half-pel costs and quarter-pel costs for the macroblocks in a GOV. After all macroblocks in a GOV are processed by the motion estimation component (220), the quarter-pel decision component (232) determines an average half-pel cost and an average quarter-pel cost for the GOV. The quarter-pel decision component (232) then makes a determination as to whether to enable or disable quarter-pel motion compensation for the next GOV based on these average costs. In some embodiments of the invention, if the average half-pel cost exceeds the average quarter-pel cost by an empirically determined threshold amount, the quarter-pel decision component (232) causes quarter-pel motion compensation to be enabled for the next GOV. In one or more embodiments of the invention, the value of the threshold is 90. Otherwise, the quarter-pel decision component (232) causes quarter-pel motion compensation to be disabled for the next GOV.

In one or more embodiments of the invention, the quarter-pel decision component (232) uses two empirically determined thresholds to determine whether to enable or disable quarter-pel motion compensation. When quarter-pel motion compensation is enabled for a GOV, a quarter-pel enabled threshold is used for evaluating the difference between the average half-pel cost and the average quarter-pel cost. When quarter-pel motion compensation is disabled for a GOV, a quarter-pel disabled threshold is used for evaluating the difference between the average half-pel cost and the average quarter-pel cost. The values of the quarter-pel enabled threshold and the quarter-pel disabled threshold may be different or may be the same. As was previously mentioned, in some embodiments of the invention, one combination of filters may be used for generating half-pel and quarter-pel values during motion estimation when quarter-pel motion compensation is enabled and a different combination of filters may be used when quarter-pel motion compensation is disabled. In some embodiments of the invention, the value of the quarter-pel enabled threshold is 60 and the value of the quarter-pel disabled threshold is 90.

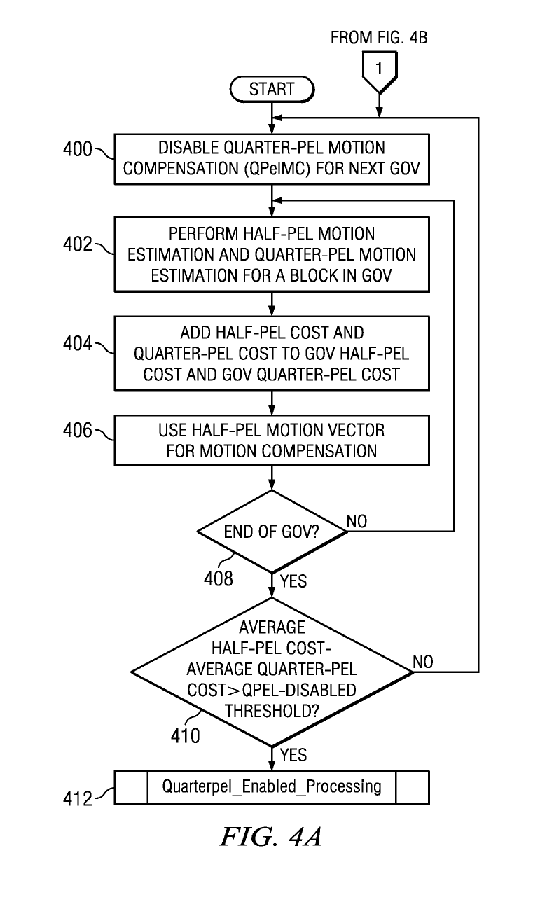

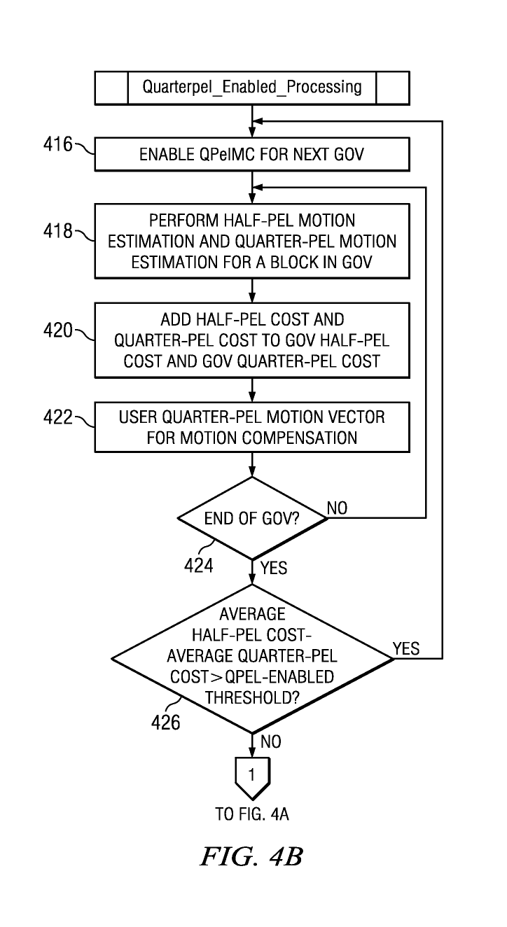

FIGS. 3, 4A, and 4B show flow graphs of methods for adaptive use of quarter-pel motion compensation during coding of a digital video sequence in accordance with one or more embodiments of the invention. In these methods, costs for using quarter-pel precision and costs for using half-pel precision are accumulated as motion estimation is performed for each block in a GOV of the digital video sequence. These costs are then used to determine whether quarter-pel motion compensation is to be enabled or disabled for the next GOV in the digital video sequence. Referring now to FIG. 3, the method begins by disabling quarter-pel motion compensation (QPelMC) for the next GOV in the digital video sequence (300). In one or more embodiments of the invention, QPelMC is disabled by setting the value of the flag “quarter_sample” as defined in MPEG-4 ASP to zero.

Half-pel motion estimation and quarter-pel motion estimation is then performed for a block in the GOV (302). More specifically, half-pel searches are performed to generate the best half-pel motion vector for the block and quarter-pel searches to generate the best quarter-pel motion vector for the block. Any suitable motion estimation technique may be used, such as, for example, a hierarchical search, a predictor-based search, a three step search, a window-based search, etc., and any suitable techniques for interpolating the half-pel and quarter-pel values for the searches may be used. In some embodiments of the invention, an M-tap filter is used to calculate the half-pel values and a bilinear filter is used to calculate the quarter-pel values from the half-pel values. In some embodiments of the invention, a bilinear filter is used to calculate both the half-pel values and the quarter-pel values. In one or more embodiments of the invention, when an M-tap filer is used, the value of M is 8 as specified by MPEG-4 ASP. In other embodiments of the invention, for purposes of performance optimization, the value of M is 6.

The best half-pel motion vector is selected based on motion vector evaluation criteria calculated for the half-pel motion vector, i.e., a half-pel cost, and the best quarter-pel motion vector is selected based on motion vector evaluation criteria calculated for the quarter-pel motion vector, i.e., a quarter-pel cost. The half-pel cost and quarter-pel cost may be calculated using any suitable technique. In some embodiments of the invention, the half-pel cost and quarter-pel cost are computed as distortion +λ*MV_cost, where the distortion is computed as the sum of absolute differences (SAD) between each pixel in the macroblock and the corresponding pixel in the reference macroblock, MV_cost (motion vector cost) represents the cost of encoding the motion vector (e.g., number of bits needed to encode the motion vector), and the parameter λ is the Lagrangian multiplier used to adjust the relative weights of the distortion and MV_cost.

The computed half-pet cost and quarter-pel cost for the block are added to GOV half-pel cost and a GOV quarter-pel cost (304), The GOV half-pel cost is the sum of the half-pel costs for the GOV and the GOV quarter-pel cost is the sum of the quarter-pel costs for the GOV, If QPelMC is currently enabled (306), the selected quarter-pel motion vector is used for motion compensation (308). Otherwise, the selected half-pel motion vector is used for motion compensation (310).

Performing half-pel and quarter-pel motion estimation, accumulating costs, etc. (302-310) are repeated until all blocks in the GOV are processed (312). When all blocks in the GOV have been processed (312), the accumulated half-pel costs and quarter-pel costs for the GOV are used to determine whether to enable or disable quarter-pel motion compensation for the next GOV. In some embodiments of the invention, if the difference between the average half-pel cost for the GOV and the average quarter-pel cost for the GOV exceeds an empirically determined threshold (314), QPelMC is enabled for the next GOV (316). In one or more embodiments of the invention, QPelMC is enabled by setting the value of the flag “quarter_sample” as defined in MPEG-4 ASP to one. Otherwise, QPelMC is disabled for the next GOV (300).

Referring now to FIGS. 4A and 4B, the method begins by disabling quarter-pel motion compensation (QPelMC) for the next GOV in the digital video sequence (400). In one or more embodiments of the invention, QPelMC is disabled by setting the value of the flag “quarter_sample” as defined in MPEG-4 ASP to zero.

Half-pel motion estimation and quarter-pel motion estimation is then performed for a block in the GOV (402). More specifically, half-pel searches are performed to generate the best half-pel motion vector for the block and quarter-pel searches to generate the best quarter-pel motion vector for the block. Any suitable motion estimation technique may be used, such as, for example, a hierarchical search, a predictor-based search, a three step search, a window-based search, etc., and any suitable techniques for interpolating the half-pel and quarter-pel values for the searches may be used. In some embodiments of the invention, a bilinear filter is used to calculate both the half-pel values and the quarter-pel values.

The best half-pel motion vector is selected based on motion vector evaluation criteria calculated for the half-pel motion vector, i.e., a half-pel cost, and the best quarter-pel motion vector is selected based on motion vector evaluation criteria calculated for the quarter-pel motion vector, i.e., a quarter-pel cost. The half-pel cost and quarter-pel cost may be calculated using any suitable technique. In some embodiments of the invention, the half-pel cost and quarter-pel cost are computed as distortion +λ*MV_cost, where the distortion is computed as the sum of absolute differences (SAD) between each pixel in the macroblock and the corresponding pixel in the reference macroblock, MV_cost (motion vector cost) represents the cost of encoding the motion vector (e.g., number of bits needed to encode the motion vector), and the parameter λ is the Lagrangian multiplier used to adjust the relative weights of the distortion and MV_cost.

The computed half-pet cost and quarter-pel cost for the block are added to GOV half-pel cost and a GOV quarter-pel cost (404). The GOV half-pel cost is the sum of the half-pel costs for the GOV and the GOV quarter-pel cost is the sum of the quarter-pel costs for the GOV. The selected half-pel motion vector is then used for motion compensation (406).

Performing half-pel and quarter-pel motion estimation, accumulating costs, etc. (402-406) are repeated until all blocks in the GOV are processed (408). When all blocks in the GOV have been processed (408), the accumulated half-pel costs and quarter-pel costs for the GOV are used to determine whether to enable or disable quarter-pel motion compensation for the next GOV. In some embodiments of the invention, if the difference between the average half-pel cost for the GOV and the average quarter-pel cost for the GOV does not exceed an empirically determined qpel-disabled threshold (410), QPelMC is disabled for the next GOV (400). In some embodiments of the invention, the value of the quarter-pel disabled threshold is 90. Otherwise, QPelMC is to be enabled for the next GOV (412).

Referring now to FIG. 4B, when QPelMC is to be enabled for the next GOV, QPelMC is enabled (416). In one or more embodiments of the invention, QPelMC is enabled by setting the value of the flag “quarter_sample” as defined in MPEG-4 ASP to one. Half-pel motion estimation and quarter-pel motion estimation is then performed for a block in the GOV (418) as previously described. In some embodiments of the invention, an M-tap filter is used to calculate the half-pel values and a bilinear filter is used to calculate the quarter-pel values.

The best half-pel motion vector is selected based on motion vector evaluation criteria calculated for the half-pel motion vector, i.e., a half-pel cost, and the best quarter-pel motion vector is selected based on motion vector evaluation criteria calculated for the quarter-pel motion vector, i.e., a quarter-pel cost. The half-pel cost and quarter-pel cost may be calculated using any suitable technique. In some embodiments of the invention, the half-pel cost and quarter-pel cost are computed as distortion +λ*MV_cost, where the distortion is computed as the sum of absolute differences (SAD) between each pixel in the macroblock and the corresponding pixel in the reference macroblock, MV_cost (motion vector cost) represents the cost of encoding the motion vector (e.g., number of bits needed to encode the motion vector), and the parameter λ is the Lagrangian multiplier used to adjust the relative weights of the distortion and MV_cost.

The computed half-pel cost and quarter-pel cost for the block are added to a GOV half-pel cost and a GOV quarter-pal cost (420). The selected quarter-pel motion vector is then used for motion compensation (422).

Performing half-pel and quarter-pel motion estimation, accumulating costs, etc. (418-422) are repeated until all blocks in the GOV are processed (424). When all blocks in the GOV have been processed (424), the accumulated half-pel costs and quarter-pel costs for the GOV are used to determine whether to enable or disable quarter-pel motion compensation for the next GOV. In some embodiments of the invention, if the difference between the average half-pel cost for the GOV and the average quarter-pel cost for the GOV exceeds an empirically determined qpel-enabled threshold (426), QPelMC is enabled for the next GOV (416). In some embodiments of the invention, the value of the quarter-pel enabled threshold is 60. Otherwise, QPelMC is disabled for the next GOV (400).

Simulations using a set of seventeen D1 test digital video sequences were performed to compare the performance of the embodiments of the methods for adaptive use of QPelMC described herein with each other and with the non-adaptive use of QPelMC. The results of these simulations are summarized in Table 1. The columns show the Bjontegaard-Delta PSNR (BD-PSNR) degradation with respect to MPEG-4 Simple Profile (half-pel) encoding of the test digital video sequences when the test digital video sequences were encoded using non-adaptive use of QPelMC and adaptive use of QPelMC using reference software. The column “Quarter pel ON” shows the BD-PSNR degradation of QPelMC in comparison to half-pel (negative numbers are degradations and positive number of gains). To generate data of the “Quarter pel ON” column, QPelMC was enabled for the entire video sequence.

The reference software was modified to perform three methods for adaptive use of QPelMC. The first method, referred to as Method 1 in the table, was an embodiment of the method of FIG. 3 and used a six-tap filter to compute the half-pel values and a bilinear filter to compute the quarter-pel values. The second method, referred to as Method 2 in the table, was also an embodiment of the method of FIG. 3 and used a bilinear filter to compute the half-pel values and a bilinear filter to compute the quarter-pel values. The threshold value used in Method 1 and Method 2 was 90. The third method, referred to as Method 3 in the table, was an embodiment of the method of FIGS. 4A and 4B. Method 3 used a six-tap filter to compute the half-pel values and a bilinear filter to compute the quarter-pel values when QPelMC was enabled and used a bilinear filter to compute both the half-pel values and the quarter-pel values when QPelMC was disabled. The qpel-disabled threshold value used was 90 and the q-pel enabled threshold value used was 60.

As can be seen in “Quarter pel ON” column of Table 1, the use of QPelMC in MPEG-4 ASP does not always provide bit-rate savings/PSNR improvement. The video sequences in rows 11-14 and 17 are the only sequences for which QPelMC provided gains over MPEG-4 SP. On average, there was a degradation of 0.17 dB when compared to MPEG-4 SP.

The use of Method 1 retained the gains for use of QPelMC for the video sequences in rows 11-14 but still showed degradations in the other sequences. This degradation is attributable to using of the 6-tap filter for computing half-pel values instead of the bilinear filter. However, note that on average, there was less coding loss as compared to “Quarter pel ON”.

The use of Method 2 also retained the gains for use of QPelMC for the video sequences in rows 11-14 and was at least as good as MPEG-4 SP in the many of the other sequences. This improvement over Method 1 is attributable to the using the bilinear filter for computing both half-pel and quarter-pel values. Note that on average, there was a 0.07 dB coding gain as compared to MPEG4 SP (half-pel).

The use of Method 3 also retained the gains for use of QPelMC for the video sequences in rows 11-14 and was at least as good as MPEG-4 SP in the many of the other sequences. Note that on average, there was a 0.1 dB coding gain as compared to MPEG4 SP (half-pel).

TABLE 1

| | | | | Method 2 | Method 3 |
|---|---|---|---|---|---|
| | | | Method 1 | (Half-pel | (Adaptive |
| | | | (Half-pel | with | selection |
| | | Quarter- | with six-tap | bilinear | of half-pel |
| | Sequence | pel ON | filter) | filter) | filter) |
| 1 | c502_p720×480_30fps_420pl_260fr | −0.41 | −0.19 | −0.06 | −0.04 |
| 2 | coastguard_p640×480_30fps_420pl_300fr | −0.35 | −0.26 | −0.17 | −0.13 |
| 3 | crew_p704×576_25fps_420pl_300fr | −0.57 | −0.21 | 0.00 | 0.00 |
| 4 | fire_p720×480_30fps_420pl_99fr | −1.25 | −0.37 | 0.00 | 0.00 |
| 5 | football_p704×480_30fps_420pl_150fr | −0.45 | −0.19 | 0.00 | 0.00 |
| 6 | foreman_p640×480_30fps_420pl_300fr | −0.30 | −0.13 | 0.02 | 0.02 |
| 7 | harbour_p704×576_25fps_420pl_300fr | −0.26 | −0.18 | −0.07 | −0.04 |
| 8 | harryPotter_p720×480_30fps_420pl_152fr | −0.36 | −0.19 | 0.00 | 0.00 |
| 9 | lce_p704×576_25fps_420pl_240fr | −0.32 | −0.18 | 0.00 | 0.00 |
| 10 | jcube_p720×480_30fps_420pl_260fr | −0.53 | −0.23 | −0.11 | −0.06 |
| 11 | mobcal_p720×480_25fps_420pl_252fr | 0.85 | 0.64 | 0.61 | 0.66 |
| 12 | mobile_p704×480_30fps_420pl_150fr | 0.81 | 0.51 | 0.36 | 0.43 |
| 13 | parkrun_p720×480_25fps_420pl_252fr | 0.58 | 0.52 | 0.44 | 0.53 |
| 14 | shields_p720×480_25fps_420pl_252fr | 0.42 | 0.35 | 0.26 | 0.36 |
| 15 | soccer_p704×576_25fps_420pl_300fr | −0.21 | −0.16 | 0.00 | 0.00 |
| 16 | starwars_p720×480_30fps_420pl_100fr | −0.71 | −0.18 | 0.00 | 0.00 |
| 17 | tennis_p704×480_30fps_420pl_150fr | 0.20 | −0.05 | −0.12 | −0.01 |
| | Average | −0.17 | −0.03 | 0.07 | 0.10 |

Embodiments of the encoders and methods described herein may be provided on any of several types of digital systems: digital signal processors (DSPs), general purpose programmable processors, application specific circuits, or systems on a chip (SoC) such as combinations of a DSP and a reduced instruction set (RISC) processor together with various specialized programmable accelerators. A stored program in an onboard or external (flash EEP) ROM or FRAM may be used to implement the video signal processing. Analog-to-digital converters and digital-to-analog converters provide coupling to the real world, modulators and demodulators (plus antennas for air interfaces) can provide coupling for transmission waveforms, and packetizers can provide formats for transmission over networks such as the Internet.

The techniques described in this disclosure may be implemented in hardware, software, firmware, or any combination thereof. If implemented in software, the software may be executed in one or more processors, such as a microprocessor, application specific integrated circuit (ASIC), field programmable gate array (FPGA), or digital signal processor (DSP). The software that executes the techniques may be initially stored in a computer-readable medium such as compact disc (CD), a diskette, a tape, a file, memory, or any other computer readable storage device and loaded and executed in the processor. In some cases, the software may also be sold in a computer program product, which includes the computer-readable medium and packaging materials for the computer-readable medium. In some cases, the software instructions may be distributed via removable computer readable media (e.g., floppy disk, optical disk, flash memory, USB key), via a transmission path from computer readable media on another digital system, etc.

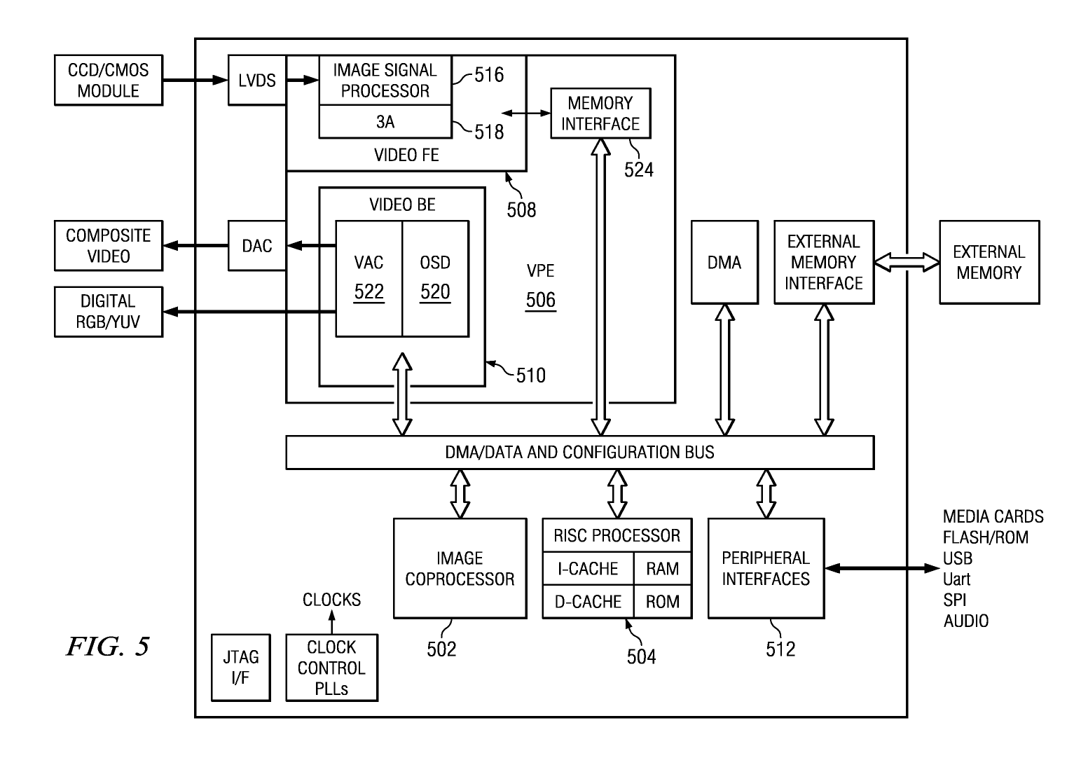

Embodiments of the methods and encoders for adaptive use of quarter-pel motion compensation as described herein may be implemented for virtually any type of digital system (e.g., a desk top computer, a laptop computer, a handheld device such as a mobile (i.e., cellular) phone, a personal digital assistant, a digital camera, etc.) with functionality to capture or otherwise generate digital video sequences. FIGS. 5-7 show block diagrams of illustrative digital systems.

FIG. 5 shows a digital system suitable for an embedded system (e.g., a digital camera) in accordance with one or more embodiments of the invention that includes, among other components, a DSP-based image coprocessor (ICP) (502), a RISC processor (504), and a video processing engine (VPE) (506) that may be configured to perform methods for adaptive use of quarter-pel motion compensation described herein. The RISC processor (504) may be any suitably configured RISC processor. The VPE (506) includes a configurable video processing front-end (Video FE) (508) input interface used for video capture from imaging peripherals such as image sensors, video decoders, etc., a configurable video processing back-end (Video BE) (510) output interface used for display devices such as SDTV displays, digital LCD panels, HDTV video encoders, etc, and memory interface (524) shared by the Video FE (508) and the Video BE (510). The digital system also includes peripheral interfaces (512) for various peripherals that may include a multi-media card, an audio serial port, a Universal Serial Bus (USB) controller, a serial port interface, etc.

The Video FE (508) includes an image signal processor (ISP) (516), and a 3A statistic generator (3A) (518). The ISP (516) provides an interface to image sensors and digital video sources. More specifically, the ISP (516) may accept raw image/video data from a sensor (CMOS or CCD) and can accept YUV video data in numerous formats. The ISP (516) also includes a parameterized image processing module with functionality to generate image data in a color format (e.g., RGB) from raw CCD/CMOS data. The ISP (516) is customizable for each sensor type and supports video frame rates for preview displays of captured digital images and for video recording modes. The ISP (516) also includes, among other functionality, an image resizer, statistics collection functionality, and a boundary signal calculator. The 3A module (518) includes functionality to support control loops for auto focus, auto white balance, and auto exposure by collecting metrics on the raw image data from the ISP (516) or external memory.

The Video BE (510) includes an on-screen display engine (OSD) (520) and a video analog encoder (VAC) (522). The OSD engine (520) includes functionality to manage display data in various formats for several different types of hardware display windows and it also handles gathering and blending of video data and display/bitmap data into a single display window before providing the data to the VAC (522) in YCbCr format. The VAC (522) includes functionality to take the display frame from the OSD engine (520) and format it into the desired output format and output signals required to interface to display devices. The VAC (522) may interface to composite NTSC/PAL video devices, S-Video devices, digital LCD devices, high-definition video encoders, DVI/HDMI devices, etc.

The memory interface (524) functions as the primary source and sink to modules in the Video FE (508) and the Video BE (510) that are requesting and/or transferring data to/from external memory. The memory interface (524) includes read and write buffers and arbitration logic.

The ICP (502) includes functionality to perform the computational operations required for video encoding and other processing of captured images. The video encoding standards supported may include one or more of the JPEG standards, the MPEG standards, and the H.26x standards. In one or more embodiments of the invention, the ICP (502) is configured to perform the computational operations of an embodiment of the methods for adaptive use of quarter-pel motion compensation as described herein.

In operation, to capture an image or video sequence, video signals are received by the video FE (508) and converted to the input format needed to perform video encoding. The video data generated by the video FE (508) is stored in then stored in external memory. The video data is then encoded by a video encoder and stored in external memory. The encoded video data may then be read from the external memory, decoded, and post-processed by the video BE (510) to display the image/video sequence.

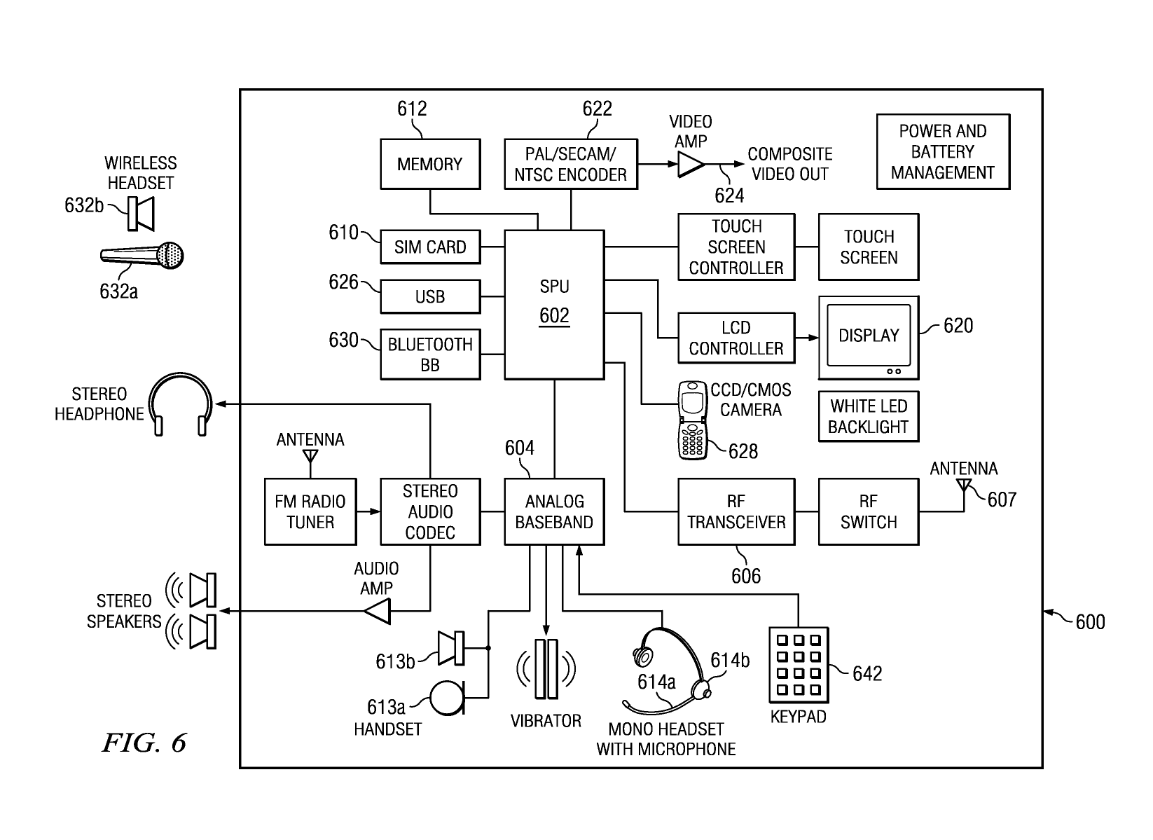

FIG. 6 is a block diagram of a digital system (e.g., a mobile cellular telephone) (600) that may be configured to perform the methods described herein. The signal processing unit (SPU) (602) includes a digital processing processor system (DSP) that includes embedded memory and security features. The analog baseband unit (604) receives a voice data stream from handset microphone (613a) and sends a voice data stream to the handset mono speaker (613b). The analog baseband unit (604) also receives a voice data stream from the microphone (614a) and sends a voice data stream to the mono headset (614b). The analog baseband unit (604) and the SPU (602) may be separate ICs. In many embodiments, the analog baseband unit (604) does not embed a programmable processor core, but performs processing based on configuration of audio paths, filters, gains, etc being setup by software running on the SPU (602). In some embodiments, the analog baseband processing is performed on the same processor and can send information to it for interaction with a user of the digital system (600) during a call processing or other processing.

The display (620) may also display pictures and video streams received from the network, from a local camera (628), or from other sources such as the USB (626) or the memory (612). The SPU (602) may also send a video stream to the display (620) that is received from various sources such as the cellular network via the RF transceiver (606) or the camera (626). The SPU (602) may also send a video stream to an external video display unit via the encoder (622) over a composite output terminal (624). The encoder unit (622) may provide encoding according to PAL/SECAM/NTSC video standards.

The SPU (602) includes functionality to perform the computational operations required for video encoding and decoding. The video encoding standards supported may include, for example, one or more of the JPEG standards, the MPEG standards, and the H.26x standards. In one or more embodiments of the invention, the SPU (602) is configured to perform the computational operations of one or more of the methods for adaptive use of quarter-pel motion compensation described herein. Software instructions implementing the one or more methods may be stored in the memory (612) and executed by the SPU (602) as part of capturing and/or encoding of digital image data, e.g., pictures and video streams.

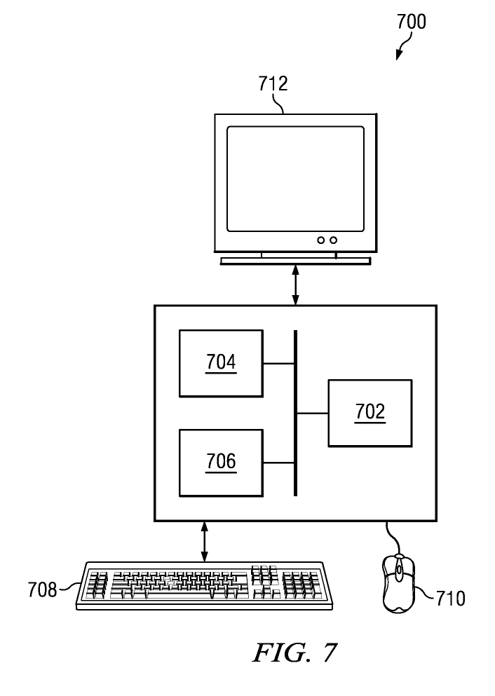

FIG. 7 shows a digital system (700) (e.g., a personal computer) that includes a processor (702), associated memory (704), a storage device (706), and numerous other elements and functionalities typical of digital systems (not shown). In one or more embodiments of the invention, a digital system may include multiple processors and/or one or more of the processors may be digital signal processors. The digital system (700) may also include input means, such as a keyboard (708) and a mouse (710) (or other cursor control device), and output means, such as a monitor (712) (or other display device). The digital system (700) may also include an image capture device (not shown) that includes circuitry (e.g., optics, a sensor, readout electronics) for capturing video sequences. The digital system (700) may include a video encoder with functionality to perform embodiments of the methods as described herein. The digital system (700) may be connected to a network (714) (e.g., a local area network (LAN), a wide area network (WAN) such as the Internet, a cellular network, any other similar type of network and/or any combination thereof) via a network interface connection (not shown). Those skilled in the art will appreciate that the input and output means may take other forms.

Further, those skilled in the art will appreciate that one or more elements of the aforementioned digital system (700) may be located at a remote location and connected to the other elements over a network. Further, embodiments of the invention may be implemented on a distributed system having a plurality of nodes, where each portion of the system and software instructions may be located on a different node within the distributed system. In one embodiment of the invention, the node may be a digital system. Alternatively, the node may be a processor with associated physical memory. The node may alternatively be a processor with shared memory and/or resources.

Software instructions to perform embodiments of the invention may be stored on a computer readable medium such as a compact disc (CD), a diskette, a tape, a file, memory, or any other computer readable storage device. The software instructions may be distributed to the digital system (700) via removable computer readable media (e.g., floppy disk, optical disk, flash memory, USB key), via a transmission path from computer readable media on another digital system, etc.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims. It is therefore contemplated that the appended claims will cover any such modifications of the embodiments as fall within the true scope and spirit of the invention.

What is claimed is:

1. A method of encoding a digital video sequence, the method comprising:
disabling quarter-pel motion compensation for a first sequence of blocks in the digital video sequence;
computing an average half-pel cost for the first sequence of blocks;
computing an average quarter-pel cost for the first sequence of blocks; and
enabling quarter-pel motion compensation for a second sequence of blocks in the digital video sequence based on a comparison of the average half-pel cost and the average quarter-pel cost.

2. The method of claim 1, wherein
computing an average half-pel cost comprises using an M-tap filter to compute half-pel values for each block in the first sequence of blocks; and
computing an average quarter-pel cost comprises using a bilinear filter to compute quarter-pel values for each block in the first sequence of blocks.

3. The method of claim 1, wherein
computing an average half-pel cost comprises using a bilinear filter to compute half-pel values for each block in the first sequence of blocks; and
computing an average quarter-pel cost comprises using a bilinear filter to compute quarter-pel values for each block in the first sequence of blocks.

4. The method of claim 1, wherein enabling quarter-pel motion compensation comprises comparing the average half-pel cost and the average quarter-pel cost using a first threshold.

5. The method of claim 1, wherein
computing an average half-pel cost comprises, for each block in the sequence of blocks, computing a cost of a best half-pel motion vector for the block; and
computing an average quarter-pel cost comprises, for each block in the sequence of blocks, computing a cost of a best quarter-pel motion vector for the block.

6. The method of claim 5, further comprising:
computing an average half-pel cost for the second sequence of blocks;
computing an average quarter-pel cost for the second sequence of blocks; and
disabling quarter-pel motion compensation for a third sequence of blocks in the digital video sequence based on a comparison of the average half-pel cost for the second sequence of blocks and the average quarter-pel cost for the second sequence of blocks.

7. The method of claim 6, wherein
computing an average half-pel cost for the first sequence of blocks comprises using a bilinear filter to compute half-pel values for each block in the first sequence of blocks;
computing an average quarter-pel cost for the first sequence of blocks comprises using a bilinear filter to compute quarter-pel values for each block in the first sequence of blocks.
computing an average half-pel cost for the second sequence of blocks comprises using an M-tap filter to compute half-pel values for each block in the second sequence of blocks; and
computing an average quarter-pel cost for the second sequence of blocks comprises using a bilinear filter to compute quarter-pel values for each block in the second sequence of blocks.

8. The method of claim 6, wherein
enabling quarter-pel motion compensation comprises comparing the average half-pel cost for the first sequence of blocks and the average quarter-pel cost for the first sequence of blocks using a first threshold; and
disabling quarter-pel motion compensation comprises comparing the average half-pel cost for the second sequence of blocks and the average quarter-pel cost for the second sequence of blocks using a second threshold.

9. A video encoder comprising:
a motion compensation component;
a motion estimation component configured to
compute a half-pel cost and a quarter-pel cost for each block in a first sequence of blocks in a digital video sequence,
provide a half-pel motion vector for each block to the motion estimation component when quarter-pel motion compensation is disabled, and
provide a quarter-pel motion vector for each block to the motion estimation component when quarter-pel motion compensation is enabled; and
a quarter-pel decision component configured to
compute an average half-pel cost and an average quarter-pel cost for the first sequence of blocks using half-pel costs and quarter-pel costs computed by the motion estimation component; and
enable or disable quarter-pel motion compensation for a second sequence of blocks in the digital video sequences based on a comparison of the average half-pel cost and the average quarter-pel cost.

10. The video encoder of claim 9, wherein the motion estimation component is configured to compute the half-pel cost for each block using an M-tap filter to compute half-pel values for the block and to compute quarter-pel cost for each block using a bilinear filter to compute quarter-pel values for the block.

11. The video encoder of claim 9, wherein the motion estimation component is configured to compute the half-pel cost for each block using a bilinear filter to compute half-pel values for the block and to compute quarter-pel cost for each block using a bilinear filter to compute quarter-pel values for the block.

12. The video encoder of claim 9, wherein the quarter-pel decision component is configured to enable or disable quarter-pel motion compensation by comparing the average half-pel cost and the average quarter-pel cost using a threshold.

13. The video encoder of claim 9, wherein the motion estimation component is configured to
compute the half-pel cost for each block using a bilinear filter to compute half-pel values for the block and to compute quarter-pel cost for each block using a bilinear filter to compute quarter-pel values for the block when quarter-pel motion estimation is enabled, and
compute the half-pel cost for each block using a bilinear filter to compute half-pel values for the block and to compute quarter-pel cost for each block using a bilinear filter to compute quarter-pel values for the block when quarter-pel motion estimation is disabled.

14. The video encoder of claim 13, wherein the quarter-pel decision component is configured to
enable or disable quarter-pel motion compensation by comparing the average half-pel cost and the average quarter-pel cost using a first threshold when quarter-pel motion estimation is disabled, and
enable or disable quarter-pel motion compensation by comparing the average half-pel cost and the average quarter-pel cost using a second threshold when quarter-pel motion estimation is enabled.

15. A digital system comprising:
a processor; and
a video encoder configured to interact with the processor to encode a digital video sequence by
disabling quarter-pel motion compensation for a first sequence of blocks in the digital video sequence;
computing an average half-pel cost for the first sequence of blocks;
computing an average quarter-pel cost for the first sequence of blocks; and
enabling quarter-pel motion compensation for a second sequence of blocks in the digital video sequence based on a comparison of the average half-pel cost and the average quarter-pel cost.

16. The digital system of claim 15, wherein
computing an average half-pel cost comprises using an M-tap filter to compute half-pel values for each block in the first sequence of blocks; and
computing an average quarter-pel cost comprises using a bilinear filter to compute quarter-pel values for each block in the first sequence of blocks.

17. The digital system of claim 15, wherein
computing an average half-pel cost comprises using a bilinear filter to compute half-pel values for each block in the first sequence of blocks; and
computing an average quarter-pel cost comprises using a bilinear filter to compute quarter-pel values for each block in the first sequence of blocks.

18. The digital system of claim 15, wherein enabling quarter-pel motion compensation comprises comparing the average half-pel cost and the average quarter-pel cost using a first threshold.

19. The digital system of claim 15, wherein
computing an average half-pel cost comprises, for each block in the sequence of blocks, computing a cost of a best half-pel motion vector for the block; and
computing an average quarter-pel cost comprises, for each block in the sequence of blocks, computing a cost of a best quarter-pel motion vector for the block.

20. The digital system of claim 19, further comprising:
computing an average half-pel cost for the second sequence of blocks;
computing an average quarter-pel cost for the second sequence of blocks; and
disabling quarter-pel motion compensation for a third sequence of blocks in the digital video sequence based on a comparison of the average half-pel cost for the second sequence of blocks and the average quarter-pel cost for the second sequence of blocks.

21. The digital system of claim 20, wherein
computing an average half-pel cost for the first sequence of blocks comprises using a bilinear filter to compute half-pel values for each block in the first sequence of blocks;
computing an average quarter-pel cost for the first sequence of blocks comprises using a bilinear filter to compute quarter-pel values for each block in the first sequence of blocks.
computing an average half-pel cost for the second sequence of blocks comprises using an M-tap filter to compute half-pel values for each block in the second sequence of blocks; and
computing an average quarter-pel cost for the second sequence of blocks comprises using a bilinear filter to compute quarter-pel values for each block in the second sequence of blocks.

22. The digital system of claim 20, wherein
enabling quarter-pel motion compensation comprises comparing the average half-pel cost for the first sequence of blocks and the average quarter-pel cost for the first sequence of blocks using a first threshold; and
disabling quarter-pel motion compensation comprises comparing the average half-pel cost for the second sequence of blocks and the average quarter-pel cost for the second sequence of blocks using a second threshold.
